(19) United States
(12) Patent Application Publication
(10) Pub. No.: US 2019/0261307 A1
(43) Pub. Date: Aug. 22, 2019

(54) CONTROL APPARATUS FOR RADIO DEVICE AND POSITION ESTIMATING METHOD

(71) Applicant: Panasonic Intellectual Property Corporation of America, Torrance, CA (US)

(72) Inventors: NAGANORI SHIRAKATA, Kanagawa (JP); HIROSHI TAKAHASHI, Kanagawa (JP); TOSHIHIDE NOBUSADA, Kanagawa (JP); AKIFUMI NAGAO, Osaka (JP); RYOSUKE UEMATSU, Osaka (JP); KENTA NAKANO, Osaka (JP)

(21) Appl. No.: 16/279,214

(22) Filed: Feb. 19, 2019

(30) Foreign Application Priority Data
Feb. 22, 2018 (JP) 2018-029706

(51) Int. Cl. H04W 64/00; G01S 5/02; H04B 13/00

(52) U.S. Cl. CPC H04W 64/003; H04B 13/005; G01S 5/0284

(57) ABSTRACT

A control apparatus for a radio device has: M intra-body communication circuits (M is an integer equal to or greater than 1) connected to N seats (N is an integer equal to or greater than 2 and greater than M) aligned mutually in contact, the M intra-body communication circuits performing intra-body communication with a radio device possessed by a user who is in contact with one of the N seats through the user; and a position estimating circuit that estimates the position of the radio device in the N seats in accordance with the reception level of a signal received from the radio device through the intra-body communication.

### BACKGROUND

### 1. Technical Field

The present disclosure relates to a control apparatus for a radio device and to a position estimating method.

### 2. Description of the Related Art

In a stadium, a hall, or another facility in which many audiences can be accommodated, a set of light-emitting devices possessed by audiences (these light-emitting devices will sometimes be referred to below as radio devices or user devices) may be used to display characters, pictures, or graphics and/or exhibit changes in color in recent years. For example, audiences possess a penlight, bracelet, or bangle that can be wirelessly controlled as a light-emitting device.

When a control apparatus wirelessly controls the light-emitting states (on and off states, for example) of individual light-emitting devices, the whole or part of an area in which light-emitting devices are aligned (that is, an area in which audiences are present in lines) is used as a performance area to, for example, display characters and/or exhibit changes in color.

For convenience, performance by a set of light-emitting devices as described above will sometimes be referred to as “collective performance” or “a light-emitting pattern”,

In collective performance, the control apparatus issues a command to change the light-emitting state to each light-emitting device according to its position. To do this, the control apparatus detects the position of each light-emitting device.

A system is disclosed in, for example, Japanese Unexamined Patent Application Publication No. 2013-006490 in which intra-body communication is performed between an operation terminal possessed by a user such as an audience and a seat on which the user is sitting to detect a seat to which the operation terminal that the user is operating is attached.

### SUMMARY

In the system disclosed in Japanese Unexamined Patent Application Publication No. 2013-006490, however, a receiver usable for intra-body communication is provided for each seat. In addition to fixed seats in a stadium or hall, If extra seats such as arena seats are installed and provided with receivers usable for intra-body communication as well, costs are increased.

One non-limiting and exemplary embodiment provides a control apparatus for a radio device, a control system, and a control method which are capable of detecting the position of a user device with a simple structure.

In one general aspect, the techniques disclosed here feature a control apparatus for a radio device has: M intra-body communication circuits (M is an integer equal to or greater than 1) connected to N seats (N is an integer equal to or greater than 2 and greater than M) aligned mutually in contact, each intra-body communication circuit performing intra-body communication with a radio device possessed by a user who is in contact with one of the N seats through the user; and a position estimating circuit that estimates the position of the radio device in the N seats in accordance with the reception level of a signal received from the radio device through the intra-body communication.

According to one aspect of the present disclosure, the position of a user device can be detected with a simple structure.

It should be noted that these comprehensive or specific aspects may be implemented as a system, an apparatus, a method, an integrated circuit, a computer program, a recording medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates an example of the structure of a position estimating system according to Embodiment 1;

FIG. 2 is a block diagram illustrating an example of the structure of a user device according to Embodiment 1;

FIG. 3 is a block diagram illustrating an example of the structure of a control apparatus according to Embodiment 1;

FIG. 4 illustrates an example of a processing sequence according to Embodiment 1;

FIG. 5 illustrates an example of reception levels in intra-body communication according to Embodiment 1;

FIG. 6 illustrates an example of the structure of a position estimating system according to Embodiment 2;

FIG. 7 illustrates an example of a processing sequence at a user according to Embodiment 2;

FIG. 8 illustrates an example of a processing sequence at another user according to Embodiment 2;

FIG. 9 illustrates an example of a processing sequence at yet another user according to Embodiment 2;

FIG. 10 illustrates an example of a processing sequence at still another user according to Embodiment 2; and

FIG. 11 illustrates an example of a relationship between UI control and distances to specified seats according to Embodiment 2.

### DETAILED DESCRIPTION

Embodiments of the present disclosure will be described below in detail with appropriate reference to the drawings. However, unnecessarily detailed descriptions may be omitted. For example, detailed descriptions about matters that are already well known and repeated descriptions about the substantially the same structure may be omitted. This is to prevent subsequent description from becoming unnecessarily redundant and is for easy understanding by those of ordinary skill in the art.

The attached drawings and subsequent description are provided so that those of ordinary skill in the art adequately understand the present disclosure, and are not intended to restrict the subject described in the scope of the claims of the present invention.

Embodiments will be described below in detail with reference to the drawings. The embodiments described below are just examples. The present disclosure is not restricted by the embodiments described below.

### Embodiment 1

Structure of a Position Estimating System

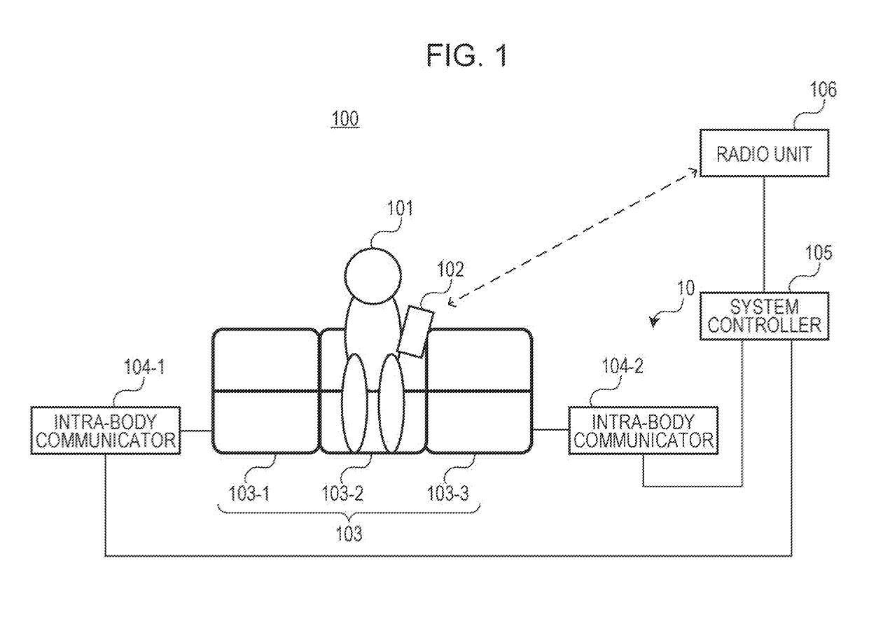

FIG. 1 illustrates an example of the structure of a position estimating system 100 according to Embodiment 1.

In FIG. 1, the position estimating system 100 includes a user device (radio device) 102 possessed by a user 101 such as an audience, a seat row 103 (composed of the seats 103-1 to 103-3), intra-body communicators 104-1 and 104-2, a system controller 105, and a radio unit 106. The intra-body communicators 104-1 and 104-2, system controller 105 and radio unit 106 constitute a control apparatus 10 that controls the user device 102. In the description below, when the intra-body communicators 104-1 and 104-2 do not need to be individually distinguished, they will sometimes be simply referred to as the intra-body communication device 104.

The position estimating system 100 is provided in a stadium, a hall, or another a facility in which many audiences (users 101) are accommodated. The position estimating system 100 estimates the position of the user device 102 possessed by the user 101 and performs collective performance through radio communication in accordance with the estimated position.

In FIG. 1, the user 101 holds the user device 102 and sits on one seat of the seat row 103 (in FIG. 1, the seat 103-2).

The user device 102 performs intra-body communication with the intra-body communicators 104 through the user 101 and seat row 103. Intra-body communication is a type of communication method in which a human body, which is a dielectric substance, is used as a transmission medium. Intra-body communication is performed by, for example, digital data modulation on coupling by electromagnetic induction, changing a magnetic field, or a current.

The seat row 103 includes the seats 103-1 to 103-3. The seats 103-1 to 103-3 are aligned so as to come into mutual contact. Specifically, the seats 103-1 to 103-3 each include a metal electric conductor; when the metal electric conductors of the seats 103-1 to 103-3 come into mutual contact, the seat row 103 can be regarded as a single conductor. For example, the seat row 103 may be formed from a plurality of seats, 103-1 to 103-3, that are integrated by joining metal frames. Alternatively, the seat row 103 may have a structure in which folding chairs (seats 103-1 to 103-3) formed from tubular metal frames are aligned so as to come into mutual contact to form a single seat row. Since the seat row 103 of this type is an electric conductor, the seat row 103 can be used as part of a transmission path in intra-body communication,

The control apparatus 10 performs intra-body communication with the user device 102, controls connections in radio communication, and controls collective performance.

Specifically, each intra-body communicator 104 is connected to the electric conductor of the seat row 103 (composed of the seats 103-1 to 103-3) and communicates with the user device 102. More specifically, the intra-body communicator 104 communicates with the user device 102 by using, as a transmission medium, the electric conductor of the seat row 103 and the human body of the user 101 who is in contact with (sitting on) the seat row 103 and is also in contact with (holding) the user device 102.

In FIG. 1, the intra-body communicator 104-1 is connected to the seat 103-1 and the intra-body communicator 104-2 is connected to the seat 103-3. That is, intra-body communicators 104 are connected to both ends of the seat row 103, one at each end. In FIG. 1, two transmission paths are formed through this connection; one is an intra-body communication transmission path between the intra-body communicator 104-1 and the user device 102 through the seat 103-1, seat 103-2, and user 101, and the other is an intra-body communication transmission path between the intra-body communicator 104-2 and the user device 102 through the seat 103-3, seat 103-2, and user 101.

The system controller 105 communicates with the user device 102 through each intra-body communicator 104 (that is, an intra-body communication transmission path) or the radio unit 106 (that is a radio transmission path) to estimate the position of the user device 102 (the position at which the user 101 is sitting), and manages connections in radio communication. The system controller 105 also controls collective performance in accordance with the position of the user device 102.

The system controller 105 is connected to the intra-body communicators 104 and radio unit 106 through, for example, a wired interface or a radio interface. A serial communication interface, a universal serial bus (USB) interface, an Ethernet (registered trademark) interface, or a wireless local area network (LAN) interface, for example, may be used as a connection interface.

The radio unit 106 performs radio communication with the user device 102. When collective performance processing is to be started, the user device 102 is controlled by radio communication (indicated by the dotted double-headed arrow) performed through the radio unit 106. When, for example, many light-emitting devices (user devices 102) for which light emitted from light emitting diodes (LEDs) is controlled are collectively used, these devices can be operated like a display apparatus that regards each user device 102 as a pixel, making it possible to produce various light emitting patterns, color scheme patterns, or images.

Structure of the User Device

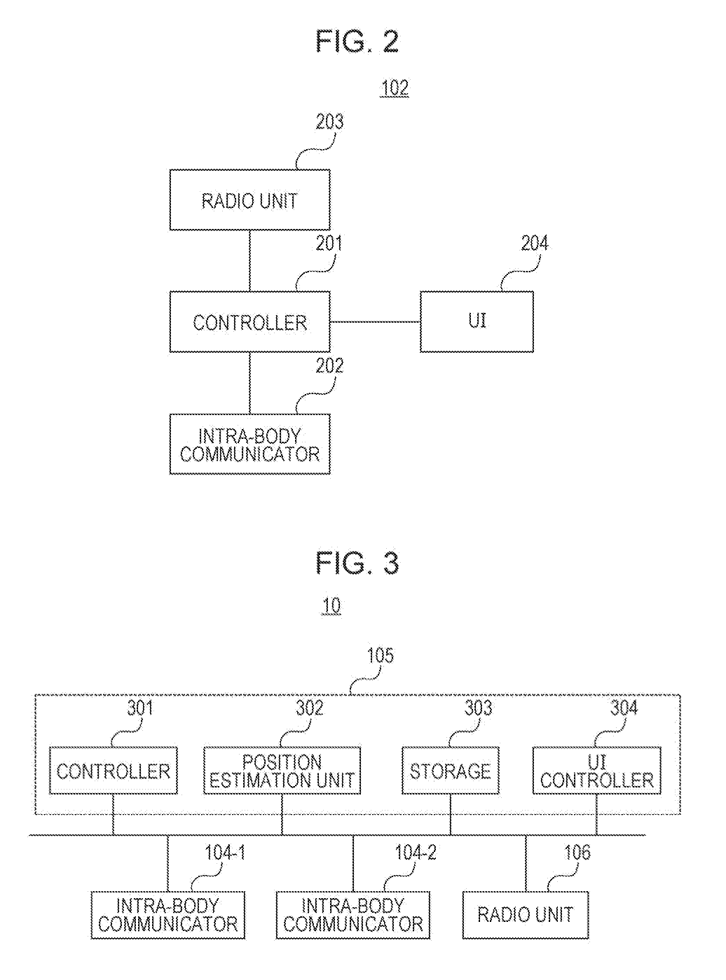

FIG. 2 is a block diagram illustrating an example of the structure of he user device 102.

In FIG. 2, the user device 102 includes a controller 201, an intra-body communicator 202, a radio unit 203, and a user interface (UI) 204.

The controller 201 controls each constituent element in the user device 102. The controller 201 is, for example, a processing device such as a microprocessor.

The intra-body communicator 202 has a contact part (not illustrated), such as an electrode, that comes into contact with a human body (that is, the user 101), a modulator (not illustrated), and a demodulator (not illustrated). The intra-body communicator 202 transmits and receives an intra-body communication signal resulting from modulating a digital signal to and from the intra-body communicator 104 (see FIG. 1).

The radio unit 203 has an antenna (not illustrated), a modulator (not illustrated), and a demodulator (not illustrated). The radio unit 203 transmits and receives a radio communication signal resulting from modulating a digital signal to and from the radio unit 106 (see FIG. 1). A radio wave in a 920 MHzband or 2.4 GHz band, for example, may be used as a radio communication signal.

The UI 204 has a user interface function. For example, the UI 204 may have a light emitter of an LED, a voice output portion of a speaker, or a vibrating portion of a vibrator. The UI 204 outputs an action to the user 101 under control of the controller 201. As an U I, the U 1294 may also output, to the controller 201, an input that is made by a switch, a microphone, or one of various types of sensors and is received from the user 101. For example, the UI 204 may output, to the controller 201, an input that is made by turning on or off a switch and is received from the user 101, a voice input received through a microphone, or an input of a user action sensed by an acceleration sensor.

Structure of the Control Apparatus

FIG. 3 is a block diagram illustrating an example of the structure of the control apparatus 10,

The system controller 105 illustrated in FIG. 3 includes a controller 301, a position estimation unit 302, a storage 303, and a UI controller 304.

The controller 301 controls the position estimating system 100. The controller 301 is, for example, a processing device such as a microprocessor or a personal computer (PC).

The position estimation unit 302 receives a signal from the intra-body communicator 104 and estimates the position of the user device 102 (that is, the position of the seat on which the user 101 is sitting) based on the reception level of the signal.

The storage 303 holds information about the user device 102 that is currently connected or information about the position of the user device 102, the position having been estimated by the position estimation unit 302. For example, the storage 303 may hold an ID that identifies a user device 102 and the estimated position of the user device 102 in correspondence to each other. The storage 303 is, for example, a hard disk drive (HDD) or a memory card.

The UI controller 304 controls collective performance in accordance with the position, held in the storage 303, of the user device 102. The UI controller 304 controls the user device 102 (specifically, the UI 204) in relation to collective performance through the radio unit 106.

Example of the Operation of the Position Estimating System 100

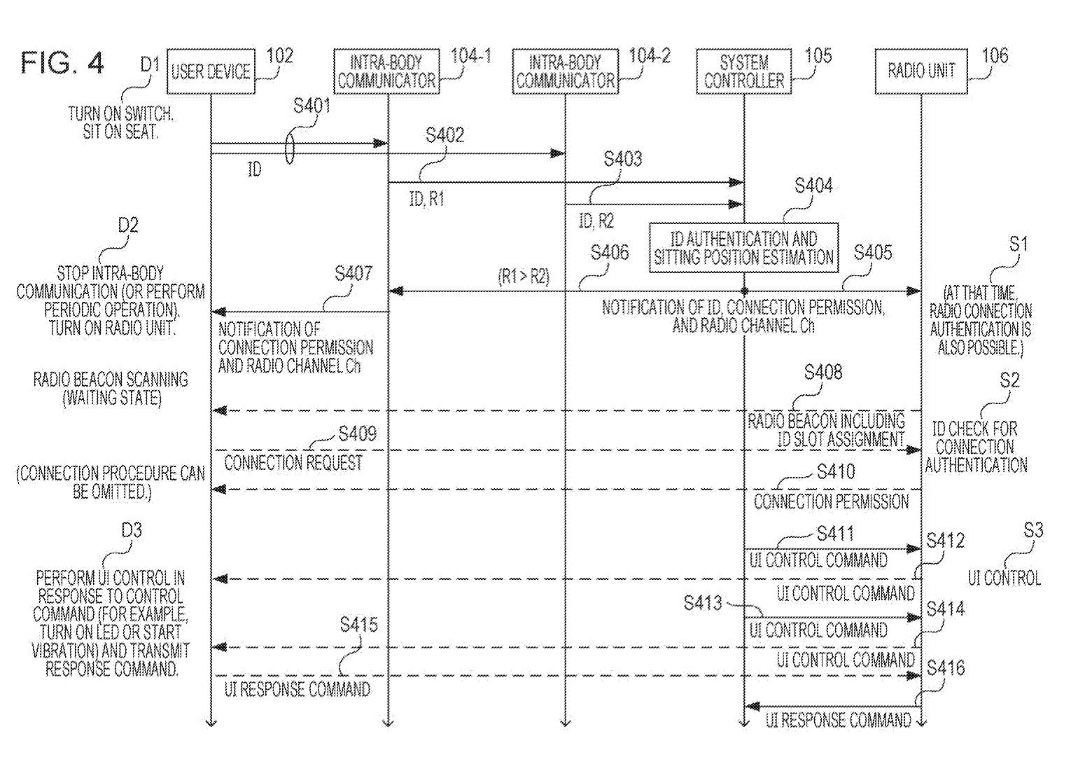

FIG. 4 illustrates an example of a sequence of processing performed by the position estimating system 100. As an example, the processing sequence in FIG. 4 illustrates processing in a case in which the user 101 sits on the seat 103-2 as illustrated in FIG. 1.

First, the user 101 turns on the power switch of the user device 102 to activate it and sits on the seat 103-2 (see FIG. 1) (state D1). In this state, intra-body communication is possible between the control apparatus 10 and the user device 102 through the user 101 and the seat row 103. The user 101 may not always sit on the seat 103-2. The user 101 only needs to be in contact with the seat 103-2.

After having been activated, the user device 102 transmits an intra-body communication signal including the identifier (ID) of the user device 102 from the intra-body communicator 202 to the intra-body communicators 104-1 and 104-2 (S401). The intra-body communication signal propagates from the user device 102 through the user 101 and the seats 103-2 and 103-1 to the intra-body communicator 104-1. The intra-body communication signal also propagates from the user device 102 through the user 101 and the seats 103-2 and 103-3 to the intra-body communicator 104-2.

When the intra-body communicator 104-1 receives the intra-body communication signal from the user device 102, the intra-body communicator 104-1 acquires the ID, included in the intra-body communication signal, of the user device 102. The intra-body communicator 104-1 also detects the reception level R1 of the intra-body communication signal. The intra-body communicator 104-1 transmits device detection data including the ID of the user device 102 and the reception level R1 to the system controller 105 (S402).

Similarly, when the intra-body communicator 104-2 receives the intra-body communication signal from the user device 102, the intra-body communicator 104-2 acquires the ID, included in the intra-body communication signal, of the user device 102. The intra-body communicator 104-2 also detects the reception level R2 of the intra-body communication signal. The intra-body communicator 104-2 transmits device detection data including the ID of the user device 102 and the reception level R2 to the system controller 105 (S403).

Upon the reception of the device detection data from the intra-body communicator 104-1 and intra-body communicator 104-2, the system controller 105 performs ID authentication for the user device 102 and estimates the sitting position (S404). For example, the position estimation unit 302 in the system controller 105 estimates the position of the user device 102 (that is, the position at which the user 101 is sitting) in the seat row 103 by using the reception levels R1 and R2 included in the device detection data items, transmitted from the intra-body communicators 104-1 and 104-2, that include the same ID (that is, the reception level for the same user device 102).

The system controller 105 may decide whether the estimated position of the user device 102 is the seat specified for the user 101 that possesses the user device 102, based on the ID, received from the intra-body communicator 104, of the user device 102. In this case, the ID of the user device 102 and the seat of the user 101 (that is, the specified seat number) has been mutually associated.

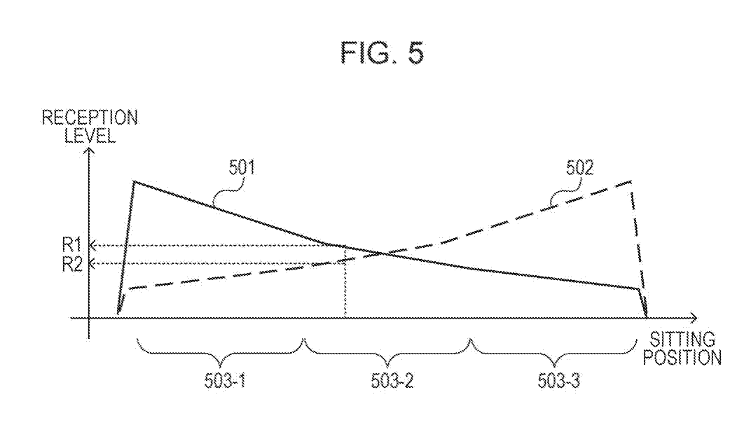

FIG. 5 illustrates an example of a relationship between reception levels and the sitting position of the user 101. In FIG. 5, the horizontal axis indicates the sitting position of the user 101 (that is, the position of the user device 102), and the vertical axis indicates the reception level detected by the intra-body communicators 104. In FIG. 5, the sitting positions 503-1, 503-2, and 503-3 respectively correspond to the positions (areas) of the seats 103-1, 103-2, and 103-3 illustrated in FIG. 1.

As seen from FIG. 5, the closer the position of the user device 102 is to the intra-body communicator 104-1 (that is, to the seat 103-1), the higher a reception level 501 at the intra-body communicator 104-1 is; the more distant the position of the user device 102 is from the intra-body communicator 104-1 (that is, from the seat 103-1), the lower the reception level 501 is. Similarly, the closer the position of the user device 102 is to the intra-body communicator 104-2 (that is, to the seat 103-3), the higher a reception level 502 at the intra-body communicator 104-2 is; the more distant the position of the user device 102 is from the intra-body communicator 104-2 (that is, from the seat 103-3), the lower the reception level 502 is.

The position estimation unit 302 measures a profile of reception levels, as illustrated in FIG. 5, of intra-body communication signals at each individual intra-body communicator 104 in advance, and estimates the relative position of the user device 102 according the difference between the reception levels of intra-body communication signals transmitted from the intra-body communicators 104.

If, for example, the user 101 holding the user device 102 sits on the seat 103-2, the reception levels R1 and R2 are predicted to become reception levels in the vicinity of the center (sitting position 503-2) on the horizontal axis in FIG. 5. That is, the reception levels R1 and R2 are predicted to become almost the same level.

If the user 101 holding the user device 102 sits on the seat 103-1, the reception levels R1 and R2 are predicted to become reception levels in the vicinity of the sitting position 503-1 in FIG. 5. That is, it is predicted that the reception level R1 will become higher that the reception level R2. If the user 101 holding the user device 102 sits on the seat 103-3, the reception levels R1 and R2 are predicted to become reception levels in the vicinity of the sitting position 503-3 in FIG. 5. That is, it is predicted that the reception level R2 will become higher that the reception level R1.

Thus, the position estimation unit 302 estimates the sitting position of the user 101 based on a relative difference between the reception level R1 at the intra-body communicator 104-1 and the reception level R2 at the intra-body communicator 104-2.

Specifically, if the difference between the reception level R1 and the reception level R2 is small (specifically, equal to or smaller than a predetermined threshold), the position estimation unit 302 estimates that the user device 102 is positioned in the vicinity of the center of the seat row 103, that is, positioned in the vicinity of the seat 103-2 (that is, in the vicinity of the sitting position 503-2). If the difference between the reception level R1 and the reception level R2 is higher than the predetermined threshold and the reception level R1 is higher than the reception level R2, the position estimation unit 302 estimates that the user device 102 is positioned in the vicinity of the seat 103-1, which is the closest to the intra-body communicator 104-1 in the seat row 103, (that is, in the vicinity of the sitting position 503-1). Similarly, if the difference between the reception level R1 and the reception level R2 is smaller than the predetermined threshold and R1 is lower than R2, the position estimation unit 302 estimates that the user device 102 is positioned in the vicinity of the seat 103-3, which is the closest to the intra-body communicator 104-2 in the seat row 103, (that is, in the vicinity of the sitting position 503-3).

The storage 303 holds the ID of the user device 102 and the position, estimated by the position estimation unit 302, of the user device 102 in correspondence to each other.

The system controller 105 authenticates the ID of the user device 102 in S404, after which the system controller 105 determines a radio channel Ch to be used in radio connection between the user device 102 and the radio unit 106. The system controller 105 then notifies the radio unit 106 of connection permission data that includes the ID of the user device 102, a connection permission, and the determined radio channel Ch (S405). At that time, user device 102 becomes ready to be connected to the position estimating system 100 (state S1). At that time, the radio unit 106 may decide that the user device 102 has been accommodated and may omit a radio connection procedure (S409 and S410, for example), which will be described later.

The system controller 105 performs intra-body communication to notify the radio unit 106 of permission of a connection to the user device 102. When notifying the radio unit 106 of permission of a connection to the user device 102, the system controller 105 may use both or either of the intra-body communicators 104-1 and 104-2. For example, the system controller 105 transmits connection permission data including the ID of the user device 102, a connection permission, and a radio channel Ch to an intra-body communicator 104 at which the reception level (R1 or R2) is high (in FIG. 4, the intra-body communicator 104-1) (S406).

After having received the connection permission data, the intra-body communicator 104-1 transmits an intra-body communication signal including the connection permission and radio channel Ch to the user device 102 corresponding to the ID included in the connection permission data (S407),

When the user device 102 receives the intra-body communication signal in S407, the user device 102 decides that a connection to the radio unit 106 has been permitted and that the radio unit 106 will start radio communication. At that time, the user device 102 turns off the intra-body communicator 202 and turns on the radio unit 203 (state D2).

If the user device 102 cannot receive an intra-body communication signal in S407 within a predetermined period after the intra-body communication signal was transmitted in S401, the user device 102 may retransmit the intra-body communication signal that the user device 102 transmitted in S401. After the user device 102 has received an intra-body communication signal in S407 and has turned off the intra-body communicator 202, the user device 102 may also turn on the intra-body communicator 202 after the elapse of a predetermined period and may perform an operation to periodically transmit an intra-body communication signal as in S401 at intervals.

After having turned on the radio unit 203, the user device 102 sets the radio unit 203 in accordance with the radio channel Ch indicated in the intra-body communication signal received in S407 and shifts to a waiting state in which a radio signal from the radio unit 106 is scanned (radio beacon scanning).

The radio unit 106 periodically transmits a radio beacon signal to the user device 102 (S408). The radio beacon signal includes information indicating the assignment of a transmission time (ID slot) during which the connected user device 102 can transmit signals.

The user device 102 receives the radio beacon signal, after which the user device 102 can perform transmission processing for the radio unit 106 by using the ID slot assigned to the ID of the user device 102. For example, the user device 102 transmits, to the radio unit 106, a radio connection request signal to request a radio connection (S409).

The radio unit 106 receives the radio connection request signal, after which the radio unit 106 checks the ID of the user device 102 for connection authentication. If the radio unit 106 permits a radio connection to the user device 102, the radio unit 106 transmits a radio connection permission signal to the user device 102 (S410). At that time, the user device 102 is placed in a state in which the user device 102 is wirelessly connected to the position estimating system 100 (state S2).

The user device 102 receives the radio connection permission signal, after which the user device 102 decides that a connection to the radio unit 106 has been established. The user device 102 then shifts to UI control performed in response to a UI control command transmitted through the radio unit 106 (state D3).

After a predetermined number of user devices 102 have been wirelessly connected (for example, when collective performance has become ready to be performed), the system controller 105 starts UI control through the radio unit 106 (state S3).

The UI controller 304 creates a UI control command that controls the UI 204 in the user device 102, in accordance with the position, estimated in S404, of each user device 102, and transmits the created UI control command to the radio unit 106 (S411). The radio unit 106 transmits a radio UI control signal including the UI control command to the user device 102 (S412). The user device 102 controls the UI 204 in response to the UI control command included in the radio UI control signal that the user device 102 has received in S412, and outputs an action to, for example, turn on the LED or operate the vibrator to the user 101.

While collective performance is being performed (state S3), a UI control command is periodically issued from the radio unit 106 and transmitted to the user device 102 (S413 and S414, for example).

If the radio unit 106 waits for the user device 102 to transmit a response to the UI control command, the ID of the user device 102 and a response request are included in the UI control command. The user device 102 receives a radio UI control signal including the response request (S414, for example). If the ID included in the UI control command matches the ID of the user device 102, the user device 102 creates a UI response command and transmits a radio UI response signal including the created UI response command to the radio unit 106 (S415). The UI response command may include information about a sensor input to the UI 204 or information about the reception level of the radio signal.

The radio unit 106 receives the radio UI response signal in S415 and notifies the system controller 105 of the UI response command included in the radio UI response signal (S416). The system controller 105 may perform UI control and position estimation by using the UI response command.

This completes the description of the operation of the position estimating system 100.

As described above, in the control apparatus 10, in this embodiment, that controls the user device 102, the intra-body communicators 104-1 and 104-2 are connected to a plurality of seats (constituting the seat row 103) aligned so as to come into mutual contact, the intra-body communicators 104-1 and 104-2 performing intra-body communication with the user device 102 possessed by the user 101 in contact with a seat through the user 101, and the position estimation unit 302 estimates the position of the user device 102 in the seat row 103 in accordance with the reception level of a signal received from the user device 102 through the intra-body communication.

As illustrated in, for example, FIG. 1, the number of intra-body communicators 104 included in the control apparatus 10 (two intra-body communicators) is smaller than the number of seats, 103-1 to 103-3, (three seats) constituting the seat row 103. That is, the control apparatus 10 does not need to have one intra-body communicator 104 for each seat included in the seat row 103. Since, in the position estimating system 100, a device used for intra-body communication (that is, the intra-body communicator 104) does not need to be provided for each seat as described above, a structure that detects the position of the user device 102 can be simplified. If, for example, the intra-body communicators 104 are connected to both ends of the seat row 103, as the number of seats constituting the seat row 103 is increased, the ratio of the number of intra-body communicators 104 to the number of seats in the seat row 103 can be more lowered.

Even if the seat row 103 is composed of a plurality of extra seats such as arena seats, only two intra-body communicators 104 are needed for the seat row 103, enabling the position estimating system 100 to have a simple structure.

In this embodiment, therefore, the position of the user device 102, which is, for example, a light-emitting device, can be detected with a simple structure.

Also, in this embodiment, the position estimation unit 302 in the control apparatus 10 estimates the position of the user device 102 (that is, the sitting position of the user 101) by comparing (that is, taking the difference between) the reception levels of intra-body communication signals transmitted between the user device 102 and a plurality of intra-body communicators 104 attached to the seat row 103. Thus, the control apparatus 10 can highly precisely estimate the position of the user device 102 regardless of the position of the seat on which the user 101 is sitting in the seat row 103.

Also, since the control apparatus 10 assigns a radio channel according to the estimated position of the user device 102 (that is, the sitting position of the user 101), a radio connection procedure can be simplified. In collective performance, therefore, the control apparatus 10 can estimate the position of the user device 102 and can establish a radio connection with a simple structure.

### Embodiment 2

In Embodiment 2, an example will be described in which the position estimating system 100 described in Embodiment 1, which uses intra-body communication and radio communication, is applied to guide the user 101 from an entrance to a specified seat in a venue.

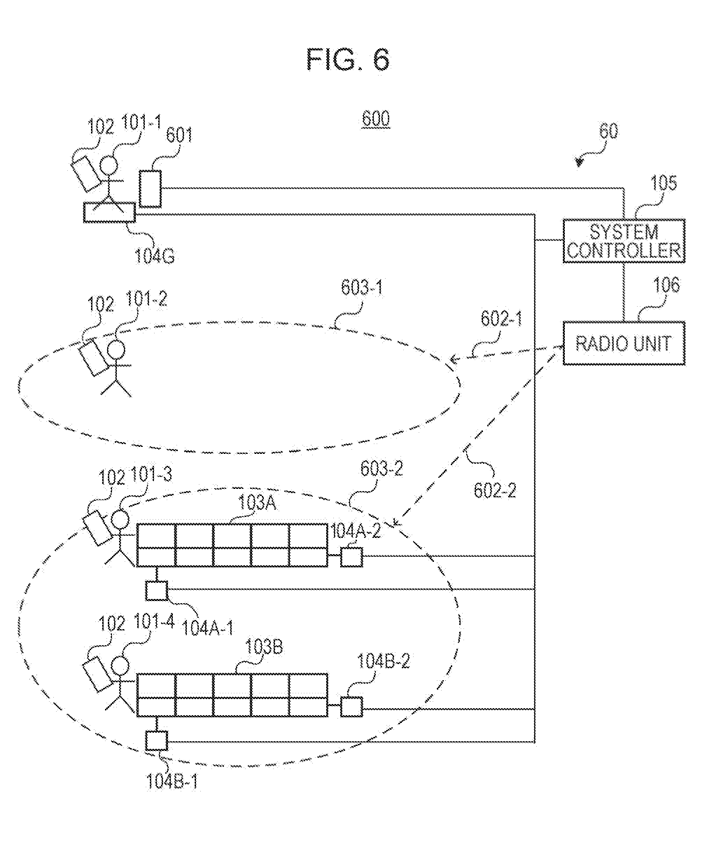

FIG. 6 illustrates an example of the structure of a position estimating system 600 according to this embodiment. The same constituent elements in FIG. 6 as in Embodiment 1 will be assigned the same reference numerals and their description will be omitted.

The position estimating system 600 estimates the position of the user device 102 (that is, the sitting position of the user 101) and performs UI control related to collective performance in accordance with the estimated position, as with the position estimating system 100 in Embodiment 1. In addition to the above processing, after the user 101 has entered the venue, the position estimating system 600 performs UI control to guide the user 101 to the seat specified for the user 101.

In the position estimating system 600 illustrated in FIG. 6, a control apparatus 60 includes a ticket gate 601, an intra-body communicator 104E attached in the vicinity of the ticket gate 601, intra-body communicators 104A-1 and 104A-2 connected to a seat row 103A, intra-body communicators 104B-1 and 104B-2 connected to a seat row 103B, the system controller 105, and the radio unit 106.

For example, the user 101 who possesses a user device 102 and a ticket on which a specified number is written checks the ticket at the ticket gate 601 disposed at the entrance and enters the venue.

In FIG. 6, a user 101-1 is at the ticket gate 601, a user 101-2 is in a communication area 603-1 at a radio channel Ch1, a user 101-3 is at a place in contact with the seat row 103A in a communication area 603-2 at a radio channel Ch2, and a user 101-4 is at a place in contact with the seat row 103B in the communication area 603-2 at the radio channel Ch2.

A radio signal 602-1 at the radio channel Ch1 is transmitted to the communication area 603-1, and a radio signal 602-2 at the radio channel Ch2 is transmitted to the communication area 603-2.

The ticket gate 601 reads the specified seat number from the ticket possessed by the user 101 and notifies the system controller 105 of information indicating the read specified seat number.

The intra-body communicator 104G is attached to a place at which the intra-body communicator 104G comes into contact with the user 101 (a place at which intra-body communication is possible) while the user 101 is checking the ticket at the ticket gate 601. The intra-body communicator 104G performs intra-body communication with the user device 102 to, for example, acquire the ID of the user device 102 and notify the system controller 105. This assures that the user 101 possesses both a ticket and a user device 102 at the same time at the same place when the user 101 enters the venue.

The system controller 105 (specifically, the storage 303) holds the ID of the user device 102, the notification of the ID being submitted from the intra-body communicator 104G, and the specified seat number, its notification being submitted from the ticket gate 601, in correspondence to each other. The system controller 105 also holds the specified seat number and the position of the specified seat in correspondence to each other. Thus, the system controller 105 can hold the ID of the user device 102, the specified seat number, and the position of the specified seat with them linked together.

The ticket may be a ticket printed on a sheet or may be an electric ticket. Alternatively, a smartphone device or the user device 102 may be used as an electric ticket. The ticket gate 601 only needs to be capable of reading specified seat numbers from these tickets and checking their validity.

The operation of the position estimating system 600 will be described below for a case in which the users 101-1, 101-2, 101-3, and 101-4, each of which possesses the user device 102, move from the ticket gate 601 to their specified seats in the seat row 103B in that order.

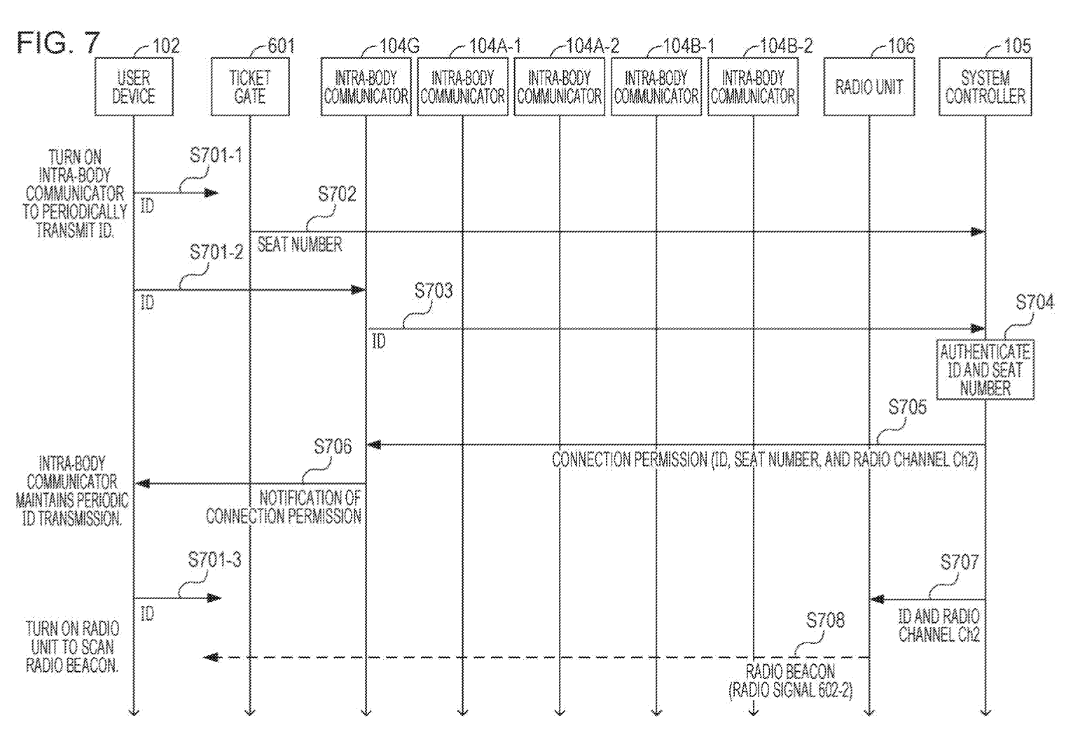

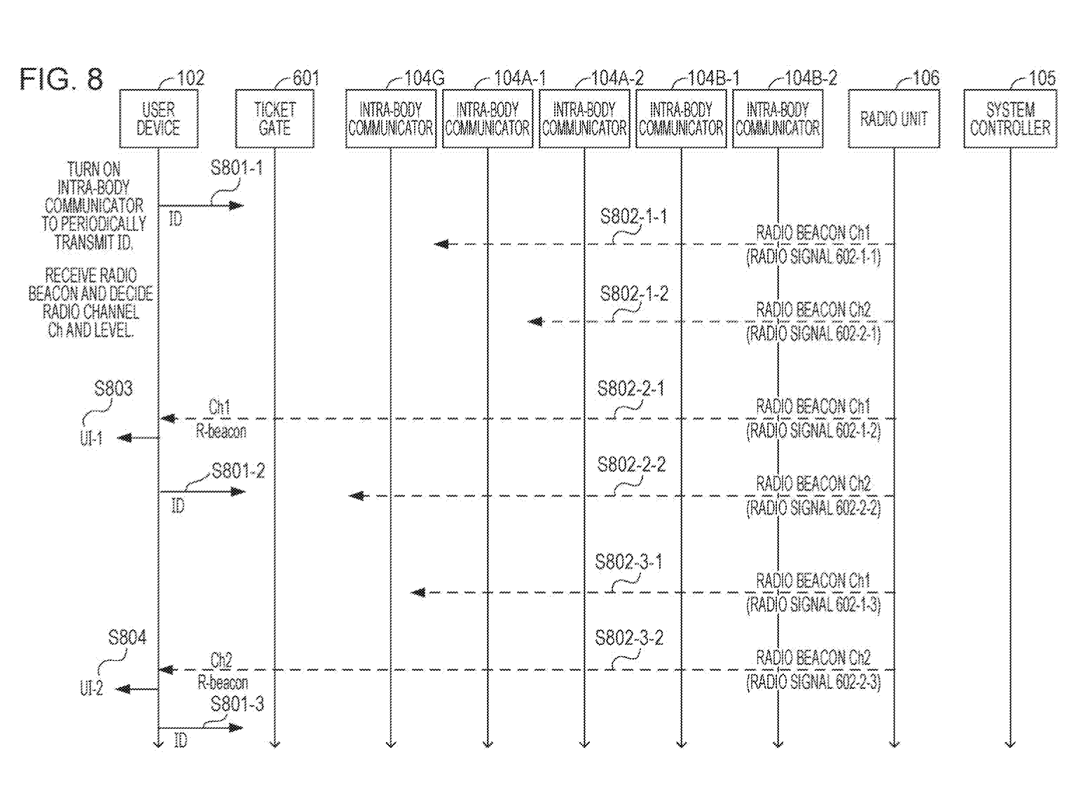

FIGS. 7 to 10 are each an example of a processing sequence followed by the position estimating system 600 for users 101 (specifically, the users 101-1 to 101-4). FIG. 11 illustrates an example of a relationship between UI control and distances between users 101 (that is, user devices 102) and a specified seat row.

The description below will assume that, as an example, the seat specified for the user 101 (that is, the specified position set for the user 101) is in the seat row 143E within the communication area 603-2 at the radio channel Ch2.

Operation for the User 101-1

FIG. 7 illustrates an example of a processing sequence between the position estimating system 600 and the user device 102 possessed by the user 101-1 in a case in which the user 101-1 checks a ticket at the ticket gate 601 disposed at the entrance.

The user device 102 turns on the intra-body communicator 202 and periodically transmits an intra-body communication signal including the ID of the user device 102 at intervals (S701-1, S701-2, and S701-3).

The user 101-1 approaches the ticket gate 601 and comes into contact with the intra-body communicator 104G, after which the ticket gate 601 reads a seat number from the ticket possessed by the user 101-1 and notifies the system controller 105 of authentication information including the read seat number (S702).

If the user 101-1 comes into contact with the intra-body communicator 104G at, for example, a timing in S701-2, a propagation path in intra-body communication is formed through the user device 102, user 101-1, and intra-body communicator 104G. In this case, an intra-body communication signal transmitted from the user device 102 is received at the intra-body communicator 104G. The intra-body communicator 104G notifies the system controller 105 of the ID of the user device 102 included in the intra-body communication signal received in S701-2 (S703).

The system controller 105 authenticates the ID of the user device 102 and the seat number specified for the user 101-1 in accordance with authentication information, a notification of which was made in S702, and the ID, a notification of which was made in S703 (S704). The system controller 105 also mutually associates the ID of the user device 102, the seat number specified for the user 101-1, and the position corresponding to the seat number.

After having authenticated the ID and seat number, the system controller 105 assigns a radio channel to the user device 102 based on the seat number. Since, in this example, the seat specified for the user 101-1 is in, for example, the seat row 103B, the system controller 105 assigns, to the user device 102 possessed by the user 101-1, the radio channel Ch2 corresponding to the communication area 603-2 including the seat row 103B. The system controller 105 then notifies the intra-body communicator 104G of a connection permission signal including information about the ID, seat number, and radio channel (S705).

The intra-body communicator 104G receives the connection permission signal in S705, after which the intra-body communicator 104G notifies the user device 102 of an intra-body communication signal including a connection permission signal through intra-body communication (S706).

The system controller 105 also notifies the radio unit 106 of the authenticated ID of the user device 102 and the assigned radio channel (in this example, the radio channel Ch2) (S707) The radio unit 106 transmits a radio beacon at the assigned radio channel to the user device 102 having the ID of which the radio unit 106 has been notified by the system controller 105 (S708). Specifically, in FIG. 7, the radio unit 106 transmits a radio signal 602-2 at the radio channel Ch2.

The user device 102 receives the connection permission signal in S706, after which the user device 102 turns on the radio unit 203 and starts to scan a radio beacon, transmitted from the radio unit 106, at the specified radio channel Ch2 while continuing to perform periodic ID transmits (in, for example, S701-3).

Operation for the User 101-2

As illustrated in FIG. 6, after the ticket and specified seat had been authenticated at the ticket gate 601, the user 101-2 has entered the venue and is now in the communication area 603-1 (which is a non-specified radio area) at the radio channel Ch1.

FIG. 8 illustrates an example of a processing sequence between the position estimating system 600 and the user device 102 possessed by the user 101-2.

The user device 102 periodically transmits an intra-body communication signal including the ID of the user device 102 while keeping the radio unit 106 turned on (S801-1, S801-2, and S801-3).

The radio unit 106 periodically transmits a radio beacon (which is a radio signal) in the communication area 603-1 at the radio channel Ch1 and the communication area 603-2 at the radio channel Ch2 (S802-1-1 to S802-3-2). That is, the radio beacon at the radio channel Ch1 is equivalent to the radio signals 602-1-1 to 602-1-3, and the radio beacon at the radio channel Ch2 is equivalent to the radio signals 602-2-1 to 602-2-3.

Each radio channel only needs to satisfy bandwidth allocation that allows a plurality of user devices 102 can be accommodated in each of a plurality of divisions constituting one communication area 603. For example, a radio channel is assigned by frequency division, time division, space division (directional division), code division, or any combination thereof.

Since the user 101-2 is positioned in the communication area 603-1, the user device 102, for example, can receive a radio beacon at the radio channel Chi (which is the radio signal 602-1-2) (S802-2-1). When the user device 102 receives a radio beacon at the radio channel Ch1 (radio signal 602-1-2), the user device 102 decides whether the channel number, which is Ch1, for the radio beacon and the reception level (R-beacon) are close to those for the seat row specified for the user device 102, in accordance with the radio channel Ch2 specified for the user device 102. The user device 102 then controls the UI 204 in accordance with a decision result (for example, a distance to the specified seat row) (S803).

The graph in (a) in FIG. 11 indicates the distance between the user device 102 and the seat specified for the user 101 on the vertical axis with respect to time on the horizontal axis. The graph in (a) in FIG. 11 indicates that the user 101 is approaching the specified seat (at which the distance is 0) from a distant position along with time.

The vertical axis of the graph in (a) in FIG. 11 can be divided in accordance with the distance from the specified seat row. For example, the vertical axis may be divided into “vicinity of specified seat row”, which is within a communication area including the specified seat row and indicates that the user 101 is in contact with the specified seat row, “vicinity of non-specified seat row”, which is within a communication area including the specified seat row and indicates that the user 101 is in contact with a set row other than the specified seat row, “within specified radio area”, which is a communication area including the specified seat, and “within non-specified radio area, which is a communication area other than a communication area including the specified seat row; these areas are closer to the specified seat row in that order.

As indicated in the graph in (a) in FIG. 11, the length of time in each segment of the distance to the specified seat is divided into a plurality of UI control segments (UI-1, UI-2, UI-3, and UI-4). Specifically, when the user 101 is positioned within the non-specified radio area, the time segment is the UI control segment UI-1; when the user 101 is positioned within the specified radio area, the time segment is the UI control segment UI-2; when the user 101 is in contact with the non-specified seat row, the time segment is the UI control segment UI-3; and when the user 101 is in contact with the specified seat row, the time segment is the UI control segment UI-4.

In different UI control segments, the UI 204 in the user device 102 presents different actions to the user 101. For example, (b) in FIG. 11 illustrates an example of a blinking pattern of an LED, (c) in FIG. 11 illustrates an example of a color change pattern of LEDs, and (d) in FIG. 11 illustrates an example of a vibration pattern of a vibrator. The UI 204 may use any one of the actions indicated in (b) to (d) in FIG. 11 or any combination of these actions.

In (b) in FIG. 11, for example, the blinking interval of the LED is shortened as time proceeds from the UI control segment UI-1 to the UI control segment UI-4. In (c) in FIG. 11, the color of the LED changes from red through blue to green as time proceeds from the UI control segment UI-1 to the UI control segment UI-4. In (d) in FIG. 11, the number of vibrations caused by the vibrator is increased as time proceeds from the UI control segment UI-1 to the UI control segment UI-4. Therefore, the user 101 can intuitively decide whether the current position of the user 101 is close to the specified seat row or the user 101 is approaching the specified seat row.

When, for example, the user 101 comes into contact with the specified seat, the UI 204 in the user device 102 may present a different action from the actions, indicated in (b), (c), and (d) in FIG. 11, taken in the UI control segments UI-1 to UI-4, to the user 101. When the user 101 comes into contact with a seat row other than the seat row specified for the user 101, the UI 204 in the user device 102 may stop the action presented to the user 101 (turn off the LED, for example). Thus, the user 101 can decide whether the user 101 has reached the specified seat (specified seat row).

The UI control segments illustrated in (a) in FIG. 11 are just an example; the UI control segments are not limited to the segments in (a) in FIG. 11. The UI control methods (blinking interval, color change, the number of vibrations, and the like) illustrated in (b), (c), and (d) in FIG. 11 are also just examples; other methods may be used. UI control methods are not limited to the UI control methods (LED blinking interval, LED color change, and the number of vibrations) illustrated in (b), (c), and (d) in FIG. 11; UI control methods only need to implement operations that can be presented to the user 101.

Although, in (a) in FIG. 11, a case is illustrated in which the user 101 approaches the specified seat along with elapsed time, the travel of the user 101 is not limited to this. Specifically, it is only necessary for the UI 204 in the user device 102 to be controlled in accordance with the distance to the specified seat (that is, the segment matching the distance), the distance changing with the travel of the user 101.

Referring again to FIG. 8, the communication area 603-1 corresponding to the radio channel Ch1 is outside the communication area 603-2 in which the seat row specified for the user 101 is present (that is, within the non-specified radio area). If the user device 102 receives a radio beacon at the radio channel Chi (radio signal 602-1-2), therefore, the user device 102 decides that the UI control segment is the UI control segment UI-1 illustrated in (a) in FIG. 11 and performs control in the UI control segment UI-1 for the UI 204, for example, as illustrated in (b), (c), or (d) in FIG. 11 (S803).

Next, it will be assumed that the user 101 travels and enters the communication area 603-2. In this case, the user device 102 receives a radio beacon (specifically, a radio signal 602-2-3) in S802-3-2. The user device 102 then decides whether the channel number, which is Ch2, for the radio beacon and the reception level (R-beacon) are close to those for the seat row specified for the user device 102, in accordance with the radio channel Ch2 specified for the user device 102.

The communication area 603-2 corresponding to the radio channel Ch2 is a communication area in which the seat row specified for the user 101 is present (that is, within the specified radio area). Therefore, the user device 102 decides that, for example, the UI control segment is the UI control segment UI-2 illustrated in (a) in FIG. 11 and performs control in the UI control segment UI-2 for the UI 204, for example, as illustrated in (b), (c), or (d) in FIG. 11 (S804). In S804, therefore, the user 101 can recognize that the user 101 is closer to the specified seat row than when the user 101 was at the position in S803.

Operation for the User 101-3

As illustrated in FIG. 6, the user 101-3 travels in the venue and is positioned in the communication area 603-2 at the radio channel Ch2 (specifically, the specified radio area) so as to be in contact with a seat row 103A, which a non-specified seat row.

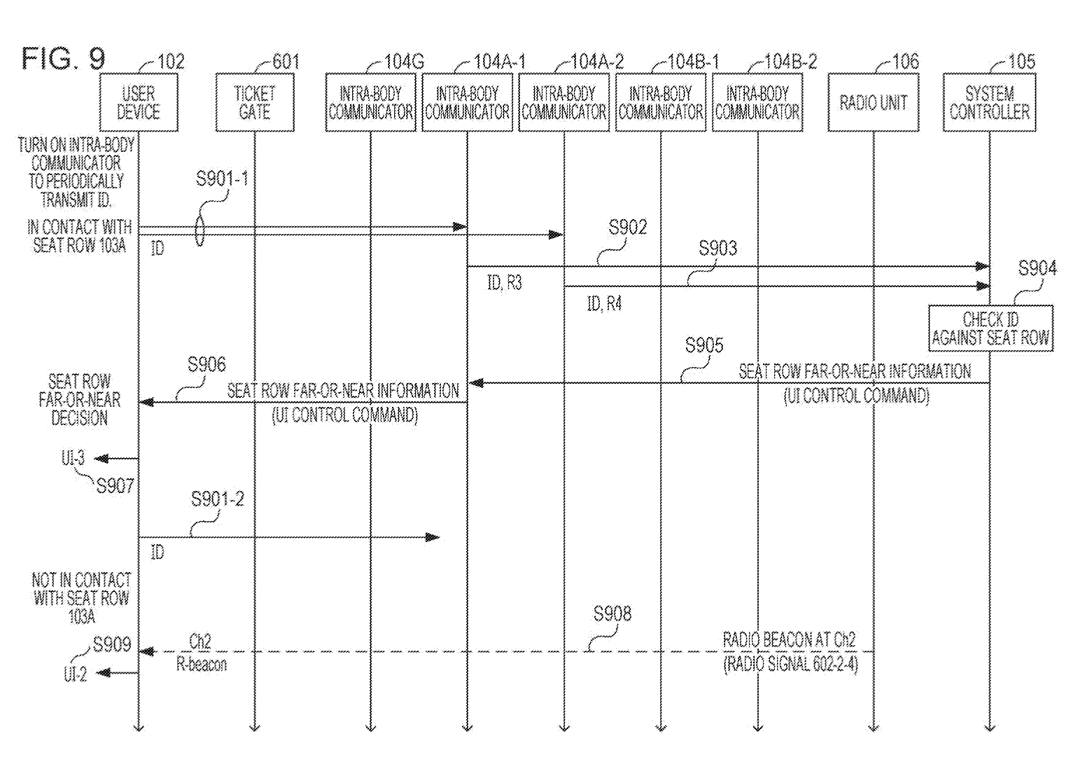

FIG. 9 illustrates an example of a processing sequence between the position estimating system 600 and the user device 102 possessed by the user 101-3.

The user device 102 periodically transmits an intra-body communication signal including the ID of the user device 102 while keeping the intra-body communicator 202 turned on (S901-1 and S901-2).

When the user 101-3 comes into contact with the seat row 103A, transmission paths in intra-body communication are formed between the user device 102 and the intra-body communicator 104A-1 and between the user device 102 and the intra-body communicator 104A-2 through the user 101 and seat row 103A. Thus, the intra-body communicators 104A-1 and 104A-2 can receive an intra-body communication signal transmitted from the user device 102 in S901-1,

After having received the intra-body communication signal in S901-1, the intra-body communicator 104A-1 notifies the system controller 105 of device detection data including the ID of the user device 102 included in the intra-body communication signal and the reception level R3 of the intra-body communication signal (S902). Similarly, after having received the intra-body communication signal in S901-1, the intra-body communicator 104A-2 notifies the system controller 105 of device detection data including the ID of the user device 102 included in the intra-body communication signal and the reception level R4 of the intra-body communication signal (S903).

The system controller 105 receives the device detection data in S902 and S903, after which the system controller 105 checks the ID of the user device 102 against the seat row 103 including the specified seat (that is, the seat number) associated with the ID of the user device 102 in FIG. 7 and creates seat row far-or-near information (S904). For example, the position estimation unit 302 estimates the distance between a seat position in the seat row 103A connected to the intra-body communicator 104 that is in intra-body communication with a user device 102 and the seat position specified for the user 101 associated with the user device 102.

Seat row far-or-near information includes, for example, the ID of the user device 102 and distance information representing the distance between the seat row 103A and the specified seat associated with the ID of the user device 102. Distance information may represent, for example, a relative distance indicating the number of rows from the specified seat row to the seat row 103A in which the user 101 is currently positioned. Alternatively, a UI command (for example, a UI control command, for the UI 204, that corresponds to one of the UI control segments UI-1 to UI-4 in (a) in FIG. 11) associated with a distance may be used instead of distance information.

The system controller 105 notifies both or either of the intra-body communicators 104A-1 and 104A-2 of seat row far-or-near information (in FIG. 9, intra-body communicator 104A-1) (S905). For example, the system controller 105 may notify the intra-body communicator 104A corresponding to the reception level R3 or R4, whichever is larger, of seat row far-or-near information.

The intra-body communicator 104A-1 transmits an intra-body communication command including the seat row far-or-near information to the user device 102 (S906).

The user device 102 decides whether the user 101 is close to the seat row specified for the user 101 based on the seat row far-or-near information included in the intra-body communication signal received in S906, and performs UI control for the UI 204 in accordance with a decision result (S907). If a UI control command is included in the seat row far-or-near information, the user device 102 may perform UI control according to the UI control command.

Since, in FIG. 9, the user 101 is positioned within the communication area 603-2 and is in contact with the seat row 103A, which is a non-specified seat row, this state corresponds to the UI control segment UI-3 illustrated in (a) in FIG. 11. Therefore, the user device 102 performs, for the UI 204, UI control (see (b), (c), and (d) in FIG. 11, for example) corresponding to the UI control segment UI-3 (S907). Thus, the user 101 can recognize that the user 101 has come yet closer to the specified seat row than when the user 101 was in the state illustrated in FIG. 8.

In FIG. 9, if the user 101-3 is not in contact with the seat row 103A, the user device 102 performs UI control according to a radio beacon (specifically, a radio signal 602-2-4) that is transmitted in S908 and is received by the user device 102 (S909). Specifically, the user device 102 receives a radio beacon (specifically, the radio signal 602-2-4) and decides whether the channel number, which is Ch2, for the radio beacon and the reception level (R-beacon) are close to those for the seat row specified for the user device 102, based on the radio channel Ch2 specified for the user device 102. Since the user 101 is positioned within the communication area 603-2 (that is, the specified radio area), this state corresponds to the UI control segment UI-2 illustrated in (a) in FIG. 11. Therefore, the user device 102 performs, for the UI 204, UI control (see (b), (c), and (d) in FIG. 11, for example) corresponding to the UI control segment UI-2 (S909).

Operation for the User 101-4

As illustrated in FIG. 6, the user 101-4 further travels in the venue and is positioned in the communication area 603-2 at the radio channel Ch2 (specifically, the specified radio area) so as to be in contact with a seat row 103B, which a specified seat row.

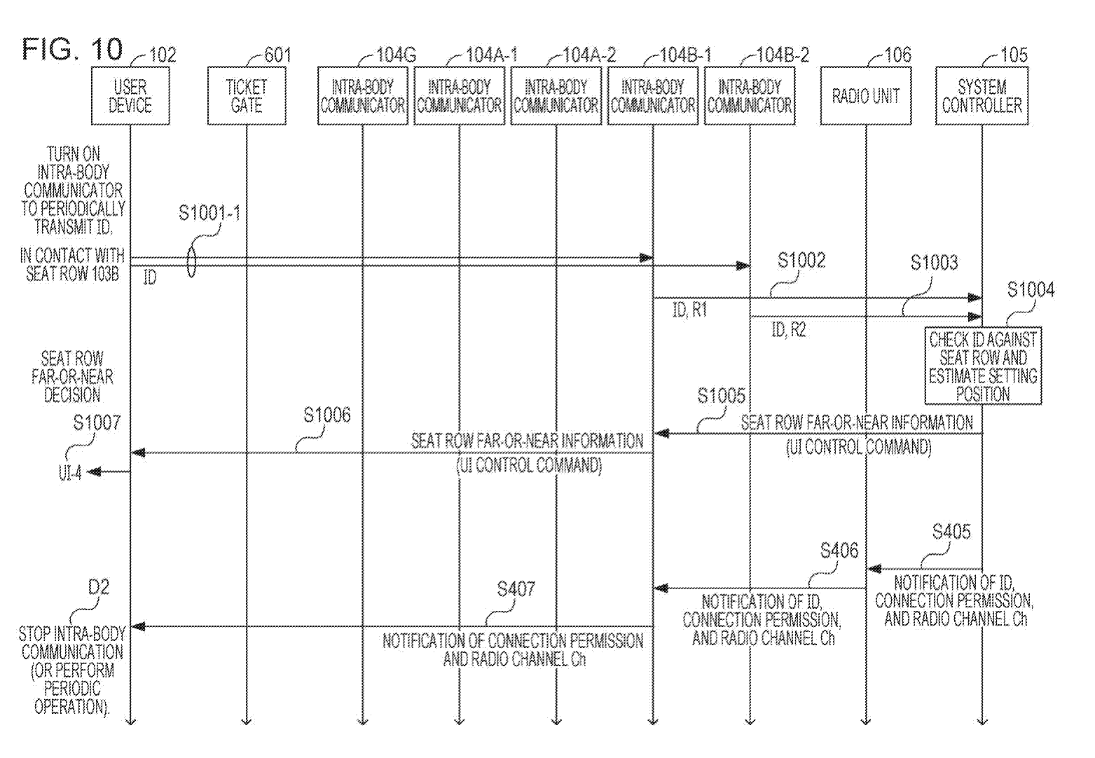

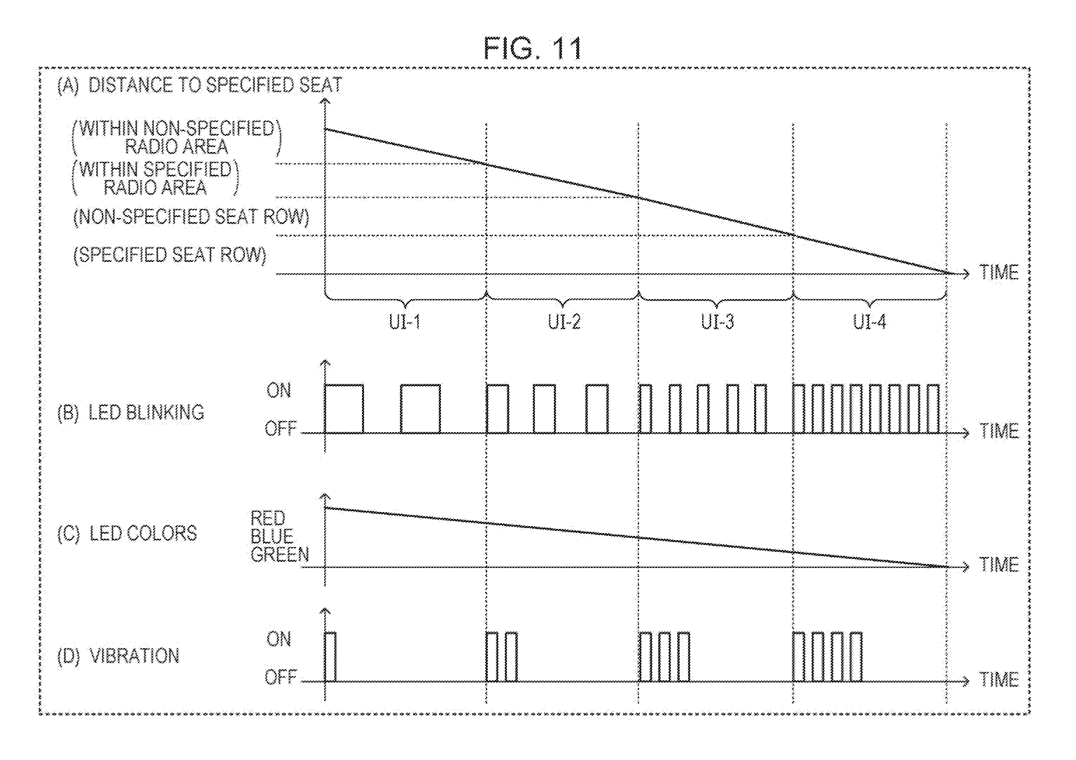

FIG. 10 illustrates an example of a processing sequence between the position estimating system 600 and the user device 102 possessed by the user 101-4.

The user device 102 periodically transmits an intra-body communication signal including the ID of the user device 102 while keeping the intra-body communicator 202 turned on (S1001-1).

When the user 101-4 comes into contact with the seat row 103B, transmission paths in intra-body communication are formed between the user device 102 and the intra-body communicator 104B-1 and between the user device 102 and the intra-body communicator 104B-2 through the user 101 and seat row 103B. Thus, the intra-body communicators 104B-1 and 104B-2 can receive an intra-body communication signal transmitted from the user device 102 in S1001-1.

After having received the intra-body communication signal in S1001-1, the intra-body communicator 104B-1 notifies the system controller 105 of device detection data including the ID of the user device 102 included in the intra-body communication signal and the reception level R1 of the intra-body communication signal (S1002). Similarly, after having received the intra-body communication signal in S1001-1, the intra-body communicator 104B-2 notifies the system controller 105 of device detection data including the ID of the user device 102 included in the intra-body communication signal and the reception level R2 of the intra-body communication signal (S1003).

The system controller 105 receives the device detection data in S1002 and S1003, after which the system controller 105 checks the ID of the user device 102 against the seat row 103 including the specified seat (that is, the seat number) associated with the ID of the user device 102 in FIG. 7 and creates seat row far-or-near information (S1004). For example, the position estimation unit 302 estimates the distance between a seat position in the seat row 103B connected to the intra-body communicator 104 that is in intra-body communication with a user device 102 and the seat position specified for the user 101 associated with the user device 102.

Seat row far-or-near information includes, for example, the ID of the user device 102 and distance information representing the distance between the seat row 103E and the specified seat associated with the ID of the user device 102. Distance information may represent, for example, a relative distance indicating the number of rows from the specified seat row to the seat row 103B in which the user 101 is currently positioned. Alternatively, a UI command (for example, a UI control command, for the UI 204, that corresponds to one of the UI control segments UI-1 to UI-4 in (a) in FIG. 11) associated with a distance may be used instead of distance information.

The system controller 105 notifies both or either of the intra-body communicators 104B-1 and 104B-2 of seat row far-or-near information (in FIG. 10, intra-body communicator 104B-1) (S1005). For example, the system controller 105 may notify the intra-body communicator 104B corresponding to the reception level R1 or R2, whichever is larger, of seat row far-or-near information.

The intra-body communicator 104B-1 transmits an intra-body communication command including the seat row far-or-near information to the user device 102 (S1006).

The user device 102 decides whether the user 101 is close to the seat row specified for the user 101 based on the seat row far-or-near information included in the intra-body communication signal received in S1006, and performs UI control for the UI 204 in accordance with a decision result (S1007). If a UI control command is included in the seat row far-or-near information, the user device 102 may perform UI control according to the UI control command.

Since, in FIG. 10, the user 101 is positioned within the communication area 603-2 and is in contact with the seat row 103B, which is the seat row specified for the user 101, this state corresponds to the UI control segment UI-4 illustrated in (a) in FIG. 11. Therefore, the user device 102 performs, for the UI 204, UI control (see (b), (c), and (d) in FIG. 11, for example) corresponding to the UI control segment UI-4 (S1007). Thus, the user 101 can recognize that the user 101 is in the vicinity of the seat specified for the user 101.

After the user 101-4 is guided by the above processing and sits on the specified seat (that is, comes into contact the specified seat), the system controller 105 uses device detection data as described in S1002 and S1003 to authenticate the ID of the user device 102 and estimate the sitting position (S1004) as in Embodiment 1, and notifies the user device 102 of a connection permission and a radio channel used for UI control performed through the radio unit 106 in S405, S406, and S407 as in FIG. 4.

This completes the description of the operation of the position estimating system 600.

According to this embodiment, the position estimation unit 302 in the control apparatus 60 estimates the distance between the position of the seat, in the seat row 103, connected to the intra-body communicator 104 that is in intra-body communication with the user device 102 and the position of the specified seat associated with the user device 102, and the UI controller 304 performs UI control for the user device 102 according to the estimated distance to the specified seat.

According to this embodiment, therefore, the position estimating system 600 can guide the user 101 from the entrance to the specified seat in the venue. That is, the user 101 can easily find the specified seat.

According to this embodiment, to guide the user 101 to the seat specified for the user 101, the position estimating system 600 can use the intra-body communicators 104 described in Embodiment 1, which are used to estimate the position of the user device 102 in the seat row 103 (that is, the sitting position). Therefore, the position estimating system 600 can perform both processing to guide the user 101 to the seat specified for the user 101 and processing to estimate the position of the user 101 in the seat row 103 with a simple structure.

In this embodiment, the user device 102 capable of performing intra-body communication may hold information about the seat specified for the user 101 (that is, the seat number). In this case, in FIG. 6, the user device 102 can notify the system controller 105 of the ID of the user device 102 and the seat specified for the user 101 through intra-body communication with the intra-body communicator 104G, eliminating the use of the ticket gate 601.

This completes the description of the embodiments.

So far, various embodiments have been described with reference to the drawings. However, it will be appreciated that the present disclosure is not limited to these embodiments. It is apparent that persons having ordinary skill in the art can devise various examples of variations and various examples of corrections, without departing from the intended scope of the claims of the present disclosure. It will be understood that these examples are of course included in the technical range of the present disclosure. Various constituent elements in the above embodiments may be arbitrarily combined, without departing from the intended scope of the present disclosure.

The structure of the position estimating system 100 illustrated in FIG. 1 and the structure of the position estimating system 600 illustrated in FIG. 6 are just examples. For example, the number of seat rows 103, the number of seats in each seat row 103, and the number of communication areas are not limited to the numbers indicated in FIGS. 1 and 6; any number of seat rows 103, any number of seats in each seat row 103, and any number of communication areas may be used.

If, for example, the number of seats aligned mutually in contact in the seat row 103 is N (N is an integer equal to or greater than 2), the number of intra-body communicators 104 connected to the seat row 103 only needs to be M (M is an integer equal to or greater than 1 and smaller than N).

With reference to FIGS. 1 and 6, a case has been described in which one intra-body communicator 104 is disposed at each end of one seat row 103 (that is, two intra-body communicators 104 are disposed for one seat row 103 (M is 2)). However, the number (M) of intra-body communicators 104 disposed for one seat row 103 is not limited to 2.

For example, one intra-body communicator 104 may be connected to either end of one seat row 103 (M is 1). Since the number of intra-body communicators 104 can be reduced in the position estimating systems 100 and 600 accordingly, the structures of the position estimating systems 100 and 600 can be further simplified.

Conversely, three or more intra-body communicators 104 may be connected to one seat row 103 (M is equal to or larger than 3 and is smaller than N). For example, intra-body communicators 104 may be connected to both ends of the seat row 103 and to an intermediate seat. Therefore, the system controller 105 can use the reception levels of intra-body communication signals measured by a plurality of intra-body communicators 104. This can improve precision in position estimation.

Although, with reference to FIGS. 1 and 6, a case has been described in which the position of a specified seat in the seat row 103 in which a plurality of seats are aligned is estimated, the position estimating systems 100 and 300 may estimate a specified seat in a seat group, composed of a plurality of seats, in a planar form (extending in the side-to-side direction and front-back direction, for example). In this case, to enable the plurality of seats included in the seat group to be regarded as a single electric conductor, it is only necessary for their electric conductors to be in mutual contact. Intra-body communicators 104 may be connected to three or more places in the seat group in a planer form. The position estimation unit 302 may estimate the position of the user device 102 in the seat group in accordance with the difference among the reception levels of signals from user devices 102 at these intra-body communicators 104. Thus, the number of intra-body communicators 104 can be further reduced and the structures of the position estimating systems 100 and 600 can be further simplified as compared with a case in which the user device 102 estimates the position in a seat row.

In the above embodiments, when a notification of a UI control command is to submitted to the user device 102, radio communication may be performed through the radio unit 106 or intra-body communication may be performed through the intra-body communicator 104. If, for example, the user 101 is in contact with a seat, a notification of a UI control command may be submitted in intra-body communication; if the user 101 is not in contact with a seat, a notification of a UI control command may be submitted in radio communication.

The present disclosure can be implemented by software, hardware, or software that works in cooperation with hardware. Each functional block used in the description of the above embodiments can be partly or entirely implemented by an LSI circuit, which is a type of integrated circuit, and each process described in the above embodiments may be partly or entirely controlled by a single LSI circuit or a combination of LSI circuits. Each LSI circuit may be formed as an individual chip, or a single chip may be formed so as to include part or all of the functional blocks. The LSI circuit may include a data input and a data output. The LSI circuit may be referred to as an IC, a system LSI circuit, a super LSI circuit, or an ultra LSI circuit depending on the difference in the degree of integration. However, the technique of implementing an integrated circuit is not limited to LSI circuits and may be realized by using a dedicated circuit, a general-purpose processor, or a special-purpose processor. In addition, a field programmable gate array (FPGA) that can be programmed after the manufacture of the LSI circuit or a reconfigurable processor in which the connections and the settings of circuit cells disposed inside the LSI circuit can be reconfigured may be used. The present disclosure can be implemented as digital processing or analogue processing. If future integrated circuit technology replaces LSI circuits as a result of the advancement of semiconductor technology or other derivative technology, the functional blocks could be integrated using the future integrated circuit technology. Biotechnology can also be applied.

In the above description, the expressions “-er” and “-or” have been used to represent constituent elements. Instead of these expressions, other words such as “circuitry”, “device”, “unit”, and “module” may be used to represent constituent elements,

Conclusion in the Present Disclosure

The control apparatus, in the present disclosure, for a radio device has: M intra-body communication circuits (M is an integer equal to or greater than 1) connected to N seats (N is an integer equal to or greater than 2 and greater than M) aligned mutually in contact, the M intra-body communication circuits performing intra-body communication with a radio device possessed by a user who is in contact with one of the N seats through the user; and a position estimating circuit that estimates the position of the radio device in the N seats in accordance with the reception level of a signal received from the radio device through the intra-body communication.

In the control apparatus in the present disclosure, the position estimating circuit estimates the position of the radio device in accordance with the difference among reception levels at the M intra-body communication circuits.

The control apparatus in the present disclosure further has a user interface (UI) control circuit that controls the UI of the radio device in accordance with the estimated position of the radio device.

The control apparatus in the present disclosure further has a radio circuit that performs radio communication with the radio device. The UI control circuit controls the UI of the radio device through the radio communication.

In the control apparatus in the present disclosure, the radio device and the position of a specified seat for the user are mutually associated, and the position estimating circuit estimates the distance between the position of a seat connected to the intra-body communication circuit that is in intra-body communication with the radio device and the position of the specified seat, which is associated with the radio device. The control apparatus further has a UI control circuit that controls the UI of the radio device in accordance with the distance.

The position estimating method in the present disclosure, in M intra-body communication circuits (M is an integer equal to or greater than 1) connected to N seats (N is an integer equal to or greater than 2 and greater than M) aligned mutually in contact, the M intra-body communication circuits performing intra-body communication with a radio device possessed by a user who is in contact with one of the N seats through the user, estimates the position of the radio device in the N seats in accordance with the reception level of a signal received from the radio device through the intra-body communication.

The present disclosure is preferable for a system hat performs collective performance.

What is claimed is:

1. A control apparatus for a radio device, the apparatus comprising:
M intra-body communication circuits (M is an integer equal to or greater than 1) connected to N seats (N is an integer equal to or greater than 2 and greater than M) aligned mutually in contact, the M intra-body communication circuits performing intra-body communication with a radio device possessed by a user who is in contact with one of the N seats through the user; and
a position estimating circuit that estimates a position of the radio device in the N seats in accordance with a reception level of a signal received from the radio device through the intra-body communication.

2. The control apparatus according to claim 1, wherein the position estimating circuit estimates the position of the radio device in accordance with a difference among reception levels at the M intra-body communication circuits.

3. The control apparatus according to claim 1, further comprising a user interface (UI) control circuit that controls a UI of the radio device in accordance with the position estimated of the radio device.

4. The control apparatus according to claim 3, further comprising a radio circuit that performs radio communication with the radio device, wherein
the UI control circuit controls the UI of the radio device through the radio communication.

5. The control apparatus according to claim 1, further comprising a user interface (UI) control circuit, wherein:
the radio device and a position of a specified seat for the user are mutually associated;
the position estimating circuit estimates a distance between a position of a seat connected to the intra-body communication circuit that is being in intra-body communication with the radio device and the position of the specified seat, which is associated with the radio device; and
the UI control circuit controls a UI of the radio device in accordance with the distance.

6. A position estimating method comprising, in M intra-body communication circuits (M is an integer equal to or greater than 1) connected to N seats (N is an integer equal to or greater than 2 and greater than M) aligned mutually in contact, the M intra-body communication circuits performing intra-body communication with a radio device possessed by a user who is in contact with one of the N seats through the user,
estimating a position of the radio device in the N seats in accordance with a reception level of a signal received from the radio device through the intra-body communication.
